(19) United States
(12) Patent Application Publication
(10) Pub. No.: US 2018/0343372 A1
(43) Pub. Date: Nov. 29, 2018

(54) PRINTED CIRCUIT BOARD AND METHOD OF CONTROLLING CAMERA

(71) Applicant: HON HAI PRECISION INDUSTRY CO., LTD., New Taipei (TW)

(72) Inventors: HSUEH-WEN LEE, New Taipei (TW); CHI-HSUN HO, New Taipei (TW); HUI-WEN WANG, New Taipei (TW); YI-TE HSIN, New Taipei (TW); CHUN-YEN KUO, New Taipei (TW)

(21) Appl. No.: 15/833,095

(22) Filed: Dec. 6, 2017

(30) Foreign Application Priority Data
May 26, 2017 (TW) 106117590

(51) Int. Cl. H04N 5/232; G06T 1/00

(52) U.S. Cl. CPC H04N 5/232; G06T 1/0007; G06T 2207/30141; G06T 2200/32; H04N 13/0203

(57) ABSTRACT

A method for controlling n number of cameras by means of a single printed circuit board (PCB) includes obtaining working attributes of each of the n number of cameras, wherein n is a positive integer. Each camera can be controlled according to the working attributes and images obtained therefrom can be stitched together under the control of an independent user device which is in communication with the PCB.

### CROSS-REFERENCE TO RELATED APPLICATIONS

This application claims priority to Taiwanese Patent Application No. 106117590 filed on May 26, 2017, the contents of which are incorporated by reference herein.

### FIELD

The present disclosure relates to control technology, and particularly to a printed circuit board (PCB) and a method of controlling cameras.

### BACKGROUND

In the field of stereoscopic photography, a plurality of cameras are used to capture stereoscopic images illustrating 360 degrees or 720 degrees. However, because a user cannot obtain a current working attributes of each of the plurality of cameras, it is not convenient for the user to control the plurality of cameras. Improvement in the art is preferred.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 illustrates a block diagram of an exemplary embodiment of a printed circuit board (PCB) including a controlling system.

FIG. 2A illustrates an exemplary embodiment of joint points included in a chip of the PCB of FIG. 1.

FIG. 2B illustrates an exemplary embodiment of a refrigeration chip installed for cooling the chip of the PCB of FIG. 1.

FIG. 2C illustrates an exemplary embodiment of cooling the chip of the PCB of FIG. 1 using a monopod.

FIG. 3 illustrates a block diagram of an exemplary embodiment of modules of the controlling system of FIG. 1.

FIG. 4 illustrates a flowchart of an exemplary embodiment of a method of controlling cameras.

FIG. 5 illustrates a flowchart of an exemplary embodiment of a method of stitching images.

FIG. 6 illustrates an example of stitching images together.

FIGS. 7A-7D illustrate examples of the stitching of images according to stitching parameters that are adjusted in response to user input.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, referencing the accompanying drawings, is illustrated by way of examples and not by way of limitation. It should be noted that references to “an” or “one” embodiment in this disclosure are not necessarily to the same embodiment, and such references mean “at least one.”

Furthermore, the term “module”, as used herein, refers to logic embodied in hardware or firmware, or to a collection of software instructions, written in a programming language, such as Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives.

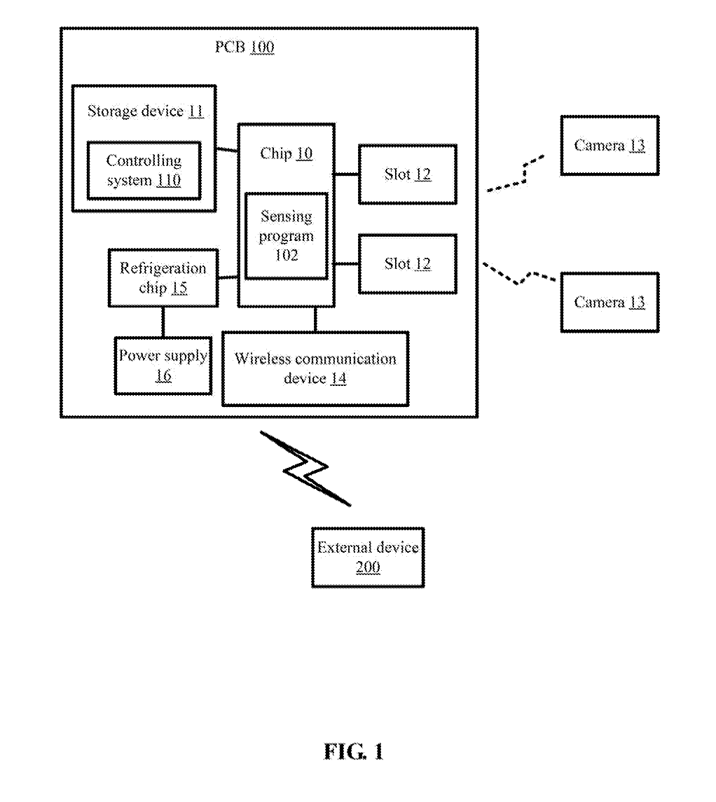

FIG. 1 illustrates a block diagram of an exemplary embodiment of a printed circuit board (PCB). Depending on the exemplary embodiment, a controlling system 110 is installed in the PCB 100. The PCB 100 can include, but is not limited to, a chip 10, a storage device 11, n number of slots 12, and a wireless communication device 14. In at least one exemplary embodiment, n number of cameras 13 can wirelessly or wired to the PCB 100. For example, the n number of cameras 13 can connect to the PCB 100 in a wired manner by respectively inserting in the n number of slots 12. For another example, the n number of cameras 13 can wirelessly connect with the PCB 100 through the wireless communication device 14.

In at least one exemplary embodiment, n can be a positive integer. For example, n may equal to four, six, eight, or ten. FIG. 1 only illustrates two slots 12 and two cameras 13.

In at least one exemplary embodiment, the chip 10 can execute the controlling system 110 that is stored in the storage device 11. The controlling system 110 can be used to control the n number of cameras 13. In at least one exemplary embodiment, the chip 10 can further include a sensing program 102. The sensing program 102 can be a software program. The chip 10 can detect which slot 12 is currently connected to a camera 13 by executing the sensing program 102.

For example, it is assumed that n equals 10. Only six slots 12 are connected to the cameras 13 (i.e., there are six cameras 13 respectively connected in six slots 12). When the chip 10 detects the six cameras 13, the chip 10 can control the six cameras 13 to capture images or videos. In at least one exemplary embodiments, various methods can be used to detect which slot 12 is connected to a camera 13.

For example, when the camera 13 is inserted in the slot 12 through a connecting line, a status of at least one circuit of the slot 12 can be changed from an non-connected status to a connected status. The chip 10 can detect which slot 12 is currently connected to a camera 13 according to the status of the at least one circuit of the slot 12.

For example, when the status of at least one circuit of a certain slot 12 of the n number of slots 12 is in the connected status, the chip 10 can determine that the certain slot 12 is connected to a camera 13.

In another example, the chip 10 can transmit a signal to each slot 12 by executing the sensing program 102, and the slot 12 that is connected with the camera 12 can send a feedback signal to the chip 10. When the chip 10 receives the feedback signal from a certain slot 12, the chip 10 can determine that the certain slot 12 is connected with the camera 13. The chip 10 can determine that the slot 12 from which no feedback signal is received is unconnected.

In at least one exemplary embodiment, when the camera 13 wirelessly connects with the chip 10, the chip 10 can transmit signals either regularly or irregularly. The camera 13 can send the feedback signal to the chip 10 when the signal from the chip 10 is received by the camera 13. When the feedback signal is received from a certain camera 13, the chip 10 can determine that normal communication can take place with the certain camera 13. The chip 10 further can determine that the camera 13 from which no feedback signal is received is not connected with the chip 10.

In other exemplary embodiments, the sensing program 102 can also be integrated with the controlling system 110. Herein, the chip 10 can execute the controlling system 110 to detect how many cameras 13 are in communication with the PCB 100.

In at least one exemplary embodiment, the n number of slots 12 are all configured on a front surface or a rear surface of the PCB 100. In other exemplary embodiments, only some of the n number of slots 12 are configured on the front surface of the PCB 100, and others are configured on the rear surface of the PCB 100.

In at least one exemplary embodiment, each of the n number of cameras 13 can connect with a slot 12 through a flexible printed circuit (FPC) line. In other exemplary embodiments, when the n number of cameras 13 are wireless cameras, the chip 10 can control the n number of cameras 13 through the wireless communication device 14. In at least one exemplary embodiment, the n number of cameras 13 have wide-angle lens or fisheye lens. In at least one exemplary embodiment, the wireless communication device 14 can be a WI-FI, BLUETOOTH, or other kind of wireless communication device such as an infrared communication device.

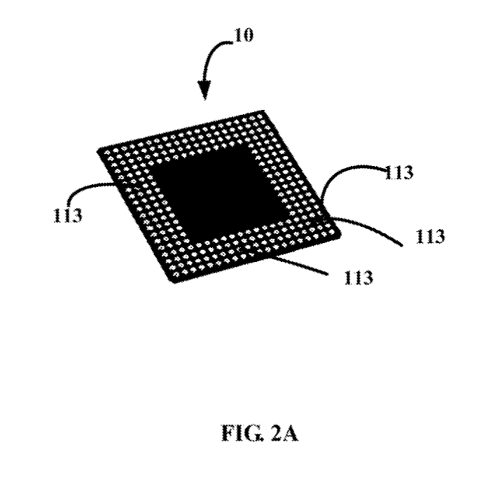

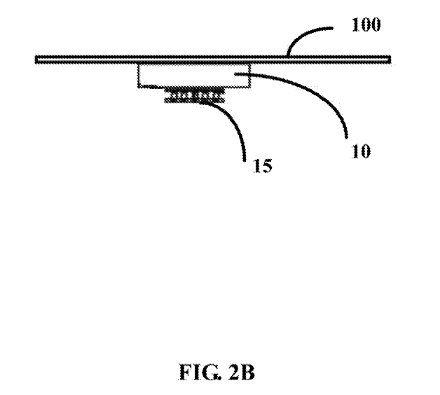

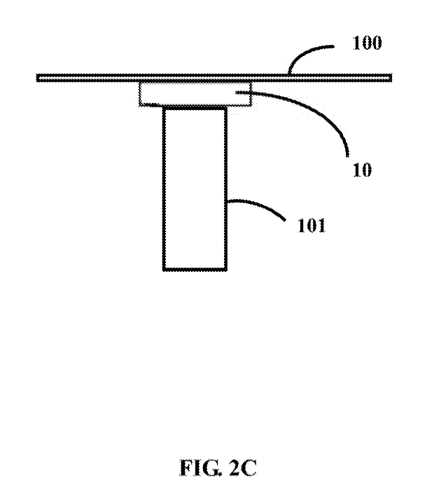

As illustrated in FIG. 2A, in at least one exemplary embodiment, the chip 10 can include a plurality of joint points 113. Each slot 12 corresponds to at least one joint point 113. Image signals of the camera 13 that is inserted in each slot 12 can be transmitted to the chip 10 through the corresponding joint point 113. In at least one exemplary embodiment, the plurality of joint points 113 can be pins, or lead frames.

In at least one exemplary embodiment, the PCB 100 can further include a refrigeration chip 15 and a power supply 16. In other exemplary embodiments, the PCB 100 does not include the refrigeration chip 15. In at least one exemplary embodiment, a first end of the refrigeration chip 15 connects with the power supply 16, and a second end of the refrigeration chip 15 connects with the chip 10. The refrigeration chip 15 can cool the chip 10, i.e., the refrigeration chip 15 can dissipate heat generated by the chip 10. It should be noted that, in actual use, as shown in FIG. 2B, the chip 10 can be located between the refrigeration chip 15 and the PCB 100, such that the refrigeration chip 15 can cool the chip 10, and dissipate heat.

In other exemplary embodiments, a heat conduction mechanism can be used to dissipate heat from the chip 10. For example, as shown in FIG. 2C, a monopod 101 can be used to dissipate heat from the chip 10.

In at least one exemplary embodiment, the power supply 16 can supply power for elements such as the chip 10 of the PCB 100.

In at least one exemplary embodiment, the PCB 100 can further communicate with an external device 200 through the wireless communication device 14. The chip 10 can wirelessly transmit working attributes of each of the n number of cameras 13 to the external device 200, such that the external device 200 can monitor the n number of cameras 13 remotely. In at least one exemplary embodiment, the external device 20 can be a remote controller, a mobile phone, a tablet computer, or any other suitable device. In at least one exemplary embodiment, the working attributes of the cameras 13 can include, but are not limited to, a working status, a temperature, and a remaining length of recording time. In at least one exemplary embodiment, the working status of the camera 13 can be defined to be whether the camera 13 is in a recording status. In at least one exemplary embodiment, the working status of the camera 13 can be recording status, non-recording status, or recording paused status.

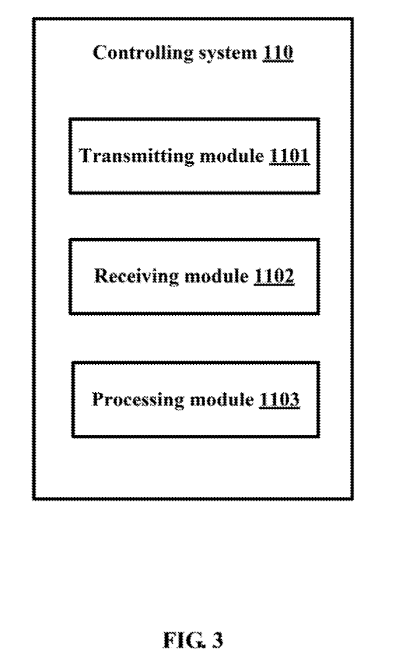

FIG. 3 illustrates a block diagram of one exemplary embodiment of modules of the controlling system 110. In at least one exemplary embodiment, the controlling system 110 can include a transmitting module 1101, a receiving module 1102, and a processing module 1103. The modules 1101-1103 include computerized codes in a form of one or more programs that may be stored in the storage device 11. The computerized codes include instructions that can be executed by the chip 10.

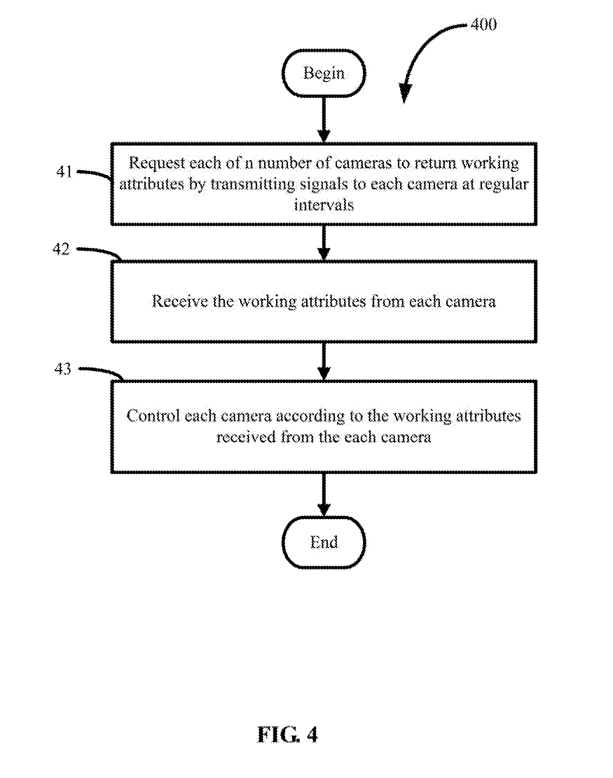

FIG. 4 illustrates a flowchart which is presented in accordance with an exemplary embodiment. The exemplary method 400 is provided by way of example, as there are a variety of ways to carry out the method. The method 400 described below can be carried out using the configurations illustrated in FIG. 1, for example, and various elements of these figures are referenced in explaining exemplary method 400. Each block shown in FIG. 4 represents one or more processes, methods, or subroutines, carried out in the exemplary method 400. Additionally, the illustrated order of blocks is by example only and the order of the blocks can be changed. The exemplary method 400 can begin at block S41. Depending on the embodiment, additional steps can be added, others removed, and the ordering of the steps can be changed.

At block 41, the transmitting module 1101 can request each of the n number of cameras 13 to return working attributes by transmitting signals of request to each camera 13 at regular intervals.

As mentioned above, n can be the positive integer, such as 1, 3, 4, 5, 6, 7, 9, 10 or another positive integer. The working attributes of the camera 13 can include, but are not limited to, the working status, the temperature, and the remaining length of recording time. In at least one exemplary embodiment, the working status of the camera 13 can be recording status, non-recording status, and recording paused status.

For example, the transmitting module 1101 can request each camera to return working attributes by transmitting signals of request to each camera 13 every five minutes.

At block 42, the receiving module 1102 can receive the working attributes from each camera 13.

In at least one exemplary embodiment, when the camera 13 receives the signal of request, the camera 13 can transmit data as to current working attributes to the chip 10, such that the receiving module 1102 can receive the data.

At block 43, the processing module 1103 can apply control to each camera 13 according to the working attributes received from the each camera 13.

For example, when a temperature of a certain camera 13 of the n number of cameras 13 is greater than a preset temperature value (e.g., 50 degrees or 100 degrees), the processing module 1103 can transmit a warning. For example, the processing module 1103 can transmit a predetermined message to the external device 200, to prompt a user of the external device 200 that the temperature of the certain camera 13 is greater than the preset temperature value. For another example, the processing module 1103 can automatically deactivate the certain camera 13 when the temperature of such camera 13 is greater than the preset temperature value.

For another example, when the remaining length of recording time of a certain camera 13 is less than a preset length of time (e.g., 1 minute or 5 minutes), the processing module 1103 can transmit a prompt. For example, the processing module 1103 can transmit a message to the external device 200 to prompt the user that only a short recording time remains.

For another example, when a current working status of a certain camera 13 is the status of non-recording, the processing module 1103 can determine whether the remaining recording time of the certain camera 13 equals zero. When the remaining recording time of the certain camera 13 is zero, the processing module 1103 can transmit a prompt. For example, the processing module 1103 can transmit a message to the external device 200 to prompt the user that the remaining length of recording time is zero and therefore the certain camera 13 is in the non-recording status.

For another example, when a current working status of a certain camera 13 is in the recording status, the processing module 1103 can detect whether an image currently captured by the certain camera 13 is blurred. A blurred image can be recognized using image recognition technology. When the image currently captured by the certain camera 13 is blurred, the processing module 1103 can transmit a prompt. For example, the processing module 1103 can transmit a message to the external device 200 to prompt the user that the image captured by the certain camera 13 is blurred. In at least one exemplary embodiment, the processing module 1103 can obtain the currently captured image from the certain camera 13, and calculate a sharpness value of the currently captured image. If the calculated sharpness value is less that a preset sharpness value, using image processing technology, the processing module 1103 can determine that the image captured by the certain camera 13 is blurred.

For another example, when a current working status of a certain camera 13 is the status of recording paused, the processing module 1103 can determine whether the certain camera 13 has already been paused for a preset length of time (e.g., 30 minutes). When the certain camera 13 pauses recording for the preset length of time, the processing module 1103 can transmit a prompt. For example, the processing module 1103 can transmit a message to the external device 200 to prompt the user that the certain camera 13 has already been paused for the preset length of time, can inactivate the certain camera 13 in response to user input.

In at least one exemplary embodiment, the processing module 1103 can further transmit the working attributes of each camera 13 to the external device 200, such that the user can use the external device 200 to remotely monitor the working status of each camera 13.

In at least one exemplary embodiment, the processing module 1103 can further receive a request from the external device 200 and respond to the request.

For example, the request from the external device 200 can be a request to adjust capturing parameters of at least one camera 13. The processing module 1103 can correspondingly adjust the capturing parameters of the at least one camera 13. In at least one exemplary embodiment, the capturing parameters can include, but are not limited, a length of exposure time, an exposure compensation value, and a sharpness value.

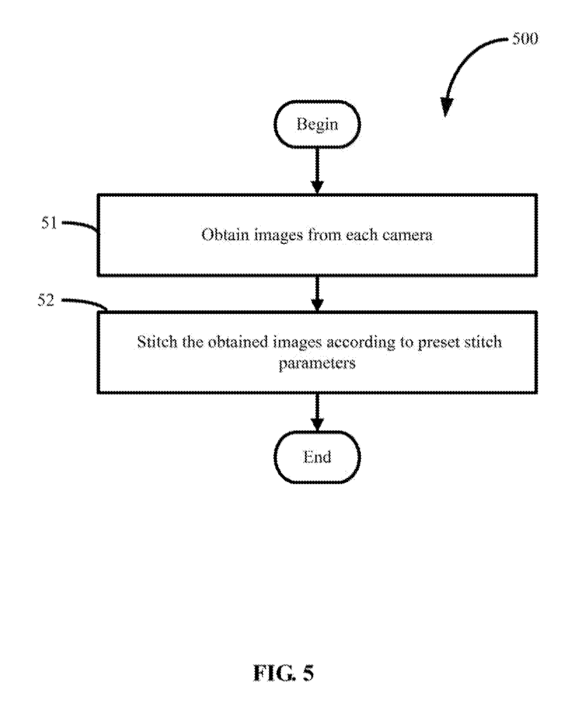

FIG. 5 illustrates a flowchart of an exemplary embodiment of a method of stitching images together. The exemplary method 500 is provided by way of example, as there are a variety of ways to carry out the method. The method 500 described below can be carried out using the configurations illustrated in FIG. 1, for example, and various elements of these figures are referenced in explaining exemplary method 500. Each block shown in FIG. 5 represents one or more processes, methods, or subroutines, carried out in the exemplary method 500. Additionally, the illustrated order of blocks is by example only and the order of the blocks can be changed. The exemplary method 500 can begin at block S51. Depending on the embodiment, additional steps can be added, others removed, and the ordering of the steps can be changed.

At block 51, the receiving module 1102 can obtain images from each camera 13.

In at least one exemplary embodiment, when each camera 13 is inserted in the slot 12 using the flexible printed circuit (FPC) line, each camera 13 can transmit the images captured by itself from the slot 12 to the chip 10 through the joint point 113 corresponding to the slot 12, such that the receiving module 1102 can obtain the images from each camera 13.

In at least one exemplary embodiment, when each camera 13 is the wireless camera, and the chip 10 communicates with each camera 13 through the wireless communication module 14, each camera 13 can transmit the images captured by itself to the chip 10 via a wireless transmitting method, such that the receiving module 1102 can receive the images from each camera 13.

At block 52, the processing module 1103 can stitch the obtained images according to preset stitch parameters.

In at least one exemplary embodiment, the preset stitch parameters can include, but are not limited to, a stitching position, an overlap extent, and a stitching order.

In at least one exemplary embodiment, the stitching position can be defined to be a position of one image that is being stitched with another image. For example, a left side of an image “A” is being stitched with a right side of an image “B”, the left side is the stitching position of the image “A”, the right side is the stitching position of the image “B”. The overlap extent can be defined to be a ratio between an overlap area of two images and a whole area of a stitched image that is obtained by stitching the two images. The stitching order can be defined to an order of stitching the obtained images. For example, it is assumed that three images “a1”, “b1”, and “c1” needs to be stitched, the order of stitching the three images can be :first, stitch images “a1” and “b1” to obtain a stitched image “a1b1”, and then stitch image “c1” with the stitched image “a1b1”.

In at least one exemplary embodiment, the processing module 1103 can stitch the obtained images and generate a stitched image.

In other exemplary embodiments, the processing module 1103 can stitch the obtained images in response to user input. For example, through a user interface provided by the external device 200, a user can designate that the images received from certain joint points 113 needed to be stitched together. In other exemplary embodiments, through the user interface, the user can designate that the images captured by certain cameras 13 needed to be stitched together.

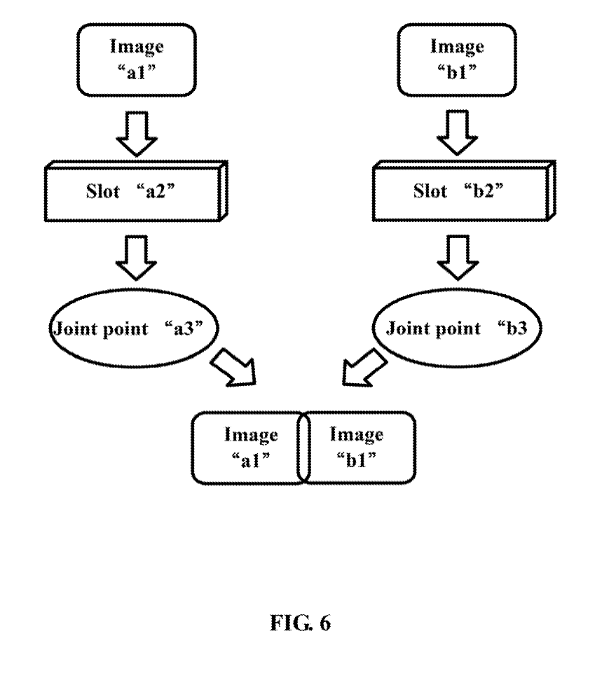

For example, as shown in FIG. 6, a camera “a” transmits an image “a1” to the chip 10 through a joint point “a3” corresponding to a slot “a2”. A camera “b” transmits an image “b1” to the chip 10 through a joint point “b3” corresponding to a slot “b2”. The processing module 1103 receives the images “al” and “b1”. The processing module 1103 can stitch a right side of the image “a1” with a left side of the image “b1”.

In other exemplary embodiments, the processing module 1103 can further adjust the preset stitching parameters in response to user input and obtain adjusted stitching parameters. The processing module 1103 can further store the adjusted stitching parameters in the storage device 11, such that the processing module 1103 can stitch images according to the adjusted stitching parameters next time.

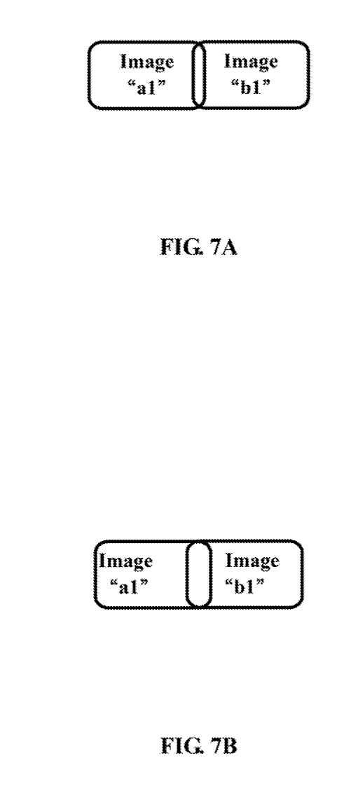

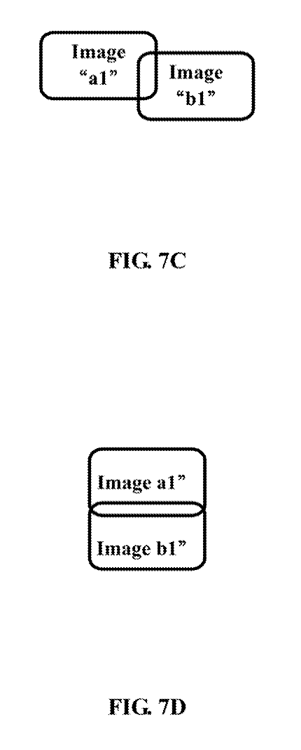

For example, as shown in FIG. 7A, the images “a1” and “b1” are stitched together according to a first overlap extent. When the first overlap extent is increased to be a second overlap extent in response to user input, the current overlap extent of the images “a1” and “b1” is increased as shown in FIG. 7B.

For another example, when the stitching position is adjusted in response to user input, the images “a1” and “b1” are stitched as shown in FIG. 7C. Similarily, according to adjustment of the stitching position, the images “a1” and “b1” can be stitched as shown in FIG. 7D.

It should be noted that, FIGS. 7A-7D illustrates examples of stitching two images. The ordinary skill in the art can understand that the above disclosure can be used to stitch more than two images, such as three images, four images, five images, six images, seven images, eight images.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. A camera controlling method comprising:
obtaining working attributes of n number of cameras, wherein n is a positive integer; and
controlling each camera according to the working attributes.

2. The camera controlling method according to claim 1, further comprising:
requesting each camera to return the working attributes by transmitting signals to each camera at regular period of time.

3. The camera controlling method according to claim 1, wherein the working attributes comprises a current working status, a current temperature, and a remaining length of recording time of the camera, wherein the current working status is selected from a group consisting of a recording status, a non-recording status, and a recording paused status.

4. The camera controlling method according to claim 1, further comprising:
transmitting a prompt when the working attributes of a certain camera of the n number of cameras do not match preset working attributes.

5. The camera controlling method according to claim 1, further comprising:
transmitting the working attributes of each camera to an external electronic device.

6. The camera controlling method according to claim 1, further comprising:
obtaining images from the n number of cameras; and
stitching the obtained images according to preset stitching parameters, and obtaining a stitched image.

7. The camera controlling method according to claim 6, wherein the preset stitching parameters comprise a stitching position, an overlap extent, and a stitching order.

8. A print circuit board (PCB) comprising:
a chip; and
a storage device;
wherein the storage device stores one or more programs, which when executed by the at chip, causes the chip to:
obtain working attributes of n number of cameras, wherein n is a positive integer; and
control each camera according to the working attributes.

9. The print circuit board according to claim 8, wherein the chip is further caused to:
request each camera to return the working attributes by transmitting signals to each camera at regular period of time.

10. The print circuit board according to claim 8, wherein the working attributes comprises a current working status, a current temperature, and a remaining length of recording time of the camera, wherein the current working status is selected from a group consisting of a recording status, a non-recording status, and a recording paused status.

11. The print circuit board according to claim 8, wherein the chip is further caused to:
transmit a prompt when the working attributes of a certain camera of the n number of cameras do not match preset working attributes.

12. The print circuit board according to claim 8, wherein the chip is further caused to:
transmit the working attributes of each camera to an external electronic device.

13. The print circuit board according to claim 8, wherein the chip is further caused to:
obtain images from the n number of cameras; and
stitch the obtained images according to preset stitching parameters, and obtain a stitched image.

14. The print circuit board according to claim 13, wherein the preset stitching parameters comprise a stitching position, an overlap extent, and a stitching order.
